(19) United States
(12) Patent Application Publication
(10) Pub. No.: US 2023/0017708 A1
(43) Pub. Date: Jan. 19, 2023

(54) System and Method for Safe Autonomous Light Aircraft

(71) Applicant: Birket IP Holdings, Inc., Hong Kong SAR (CN)

(72) Inventor: David Wayne Russell, Winter Garden, FL (US)

(73) Assignee: Birket IP Holdings, Inc., Hong Kong SAR (CN)

(21) Appl. No.: 17/686,864

(22) Filed: Mar. 4, 2022

Related U.S. Application Data
(63) Continuation of application No. 16/089,357, filed on Sep. 27, 2018, now abandoned.
(60) Provisional application No. 62/315,979, filed on Mar. 31, 2016.

(51) Int. Cl. B64C 29/00; B64C 39/02; B64C 37/00; G05D 1/00; G05D 1/10; B60F 5/02; G08G 5/00; G08G 5/02

(52) U.S. Cl. CPC B64C 29/0016; B64C 39/02; B64C 37/00; B64C 39/024; G05D 1/00; G05D 1/102; B60F 5/02; G05D 1/0022; G05D 1/0061; G08G 5/0013; G08G 5/0065; G08G 5/0069; G08G 5/025; B64C 2201/141; B64C 2201/108; B64C 2201/128; B64C 2201/146; B64C 2201/162; B64C 2201/187; B64C 2201/208

(57) ABSTRACT

Unmanned Aerial Vehicles also known as UAVs or Drones, either autonomous or remotely piloted, are classified as drones by the US Federal Aviation Administration (FAA) as weighing under 212 pounds. The system described herein details Autonomous Flight Vehicles (AFV) which weigh over 212 pounds but less than 1,320 pounds which may require either a new classification or a classification such as Sport Light Aircraft, but without the requirement of a pilot due to the safe autonomous flight system such as the Safe Temporal Vector Integration Engine or STeVIE. Safe Autonomous Light Aircraft (SALA) are useful as drone carriers, large scale air package or cargo transport, and even human transport depending on the total lift capability of the platform.

### CROSS-REFERENCE TO RELATED APPLICATIONS

THIS APPLICATION IS A CONTINUTATION OF U.S. NON-PROVISIONAL APPLICATION SERIAL NO. 16/089,357, FILED SEPTEMBER 27, 2018, WHICH WAS THE § 371 NATIONAL STAGE OF INTERNATIONAL APPLICATION SERIAL NO. PCT/US2017/025165, FILED ON MARCH 30, 2017, WHICH CLAIMS THE BENEFIT OF U.S. PROVISIONAL APPLICATION SERIAL NO. 62/315,979, FILED ON MARCH 31, 2016, THE CONTENTS OF WHICH APPLICATIONS ARE HEREBY INCORPORATED BY REFERENCE IN THEIR ENTIRETY.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMP ACT DISK APPENDIX

Not Applicable

### FIELD

This invention relates generally to the field of automatic or autonomous vehicles and more specifically to a safe command and control methodology for autonomous light aircraft.

### BACKGROUND

UAVs or drones have proven to be useful tools in a number of industries but safety concerns and weight limitations limit their utility. Utilization of efficient motor-generator sets to create electricity from liquid fuel and higher efficiency motors lead to autonomous platforms with much higher lift capabilities, range, and safety, but above a given total weight such as but not limited 212 pounds, the vehicle may no longer considered a “drone” or UAV and is instead may be classified as Sport Light Aircraft, except that these craft do not require pilots. Other examples of light aircraft are over 125 models of fixed wing and glider aircraft. Aviation rules and regulations are changing at an increased rate, one practiced in the art would see that the actual weight limit and capacity might change without altering the intention of this invention.

While a number of companies now are attempting “flying cars”, such as Terrafugia, Audi, Moller, Aeromobil, and Hoverbike, the problem that prevents almost all of these attempts from mainstream viability is the unfortunate fact that the driver must be a certified pilot to fly one.

Increased lift capability is particularly useful in drone carrier vehicles, cargo transfer vehicles, and even human transport vehicles, and made even more effective if the requirement for a human pilot can be removed. The advent of fully autonomous drones implemented with full flight control systems such as but not limited to the Safe Temporal Vector Integration Engine (STeVIE) and/or the added lift capability of these new platforms, makes this possible. Fully autonomous vehicles for human transport are being investigated without liquid fuel engines, but these have very limited range and flight duration. In addition, new FAA Air Traffic Control concepts including Beyond Line of Sight (BLOS) autonomous vehicle trajectories via 4D autorouting make it possible to achieve Safe Autonomous Light Aircraft in addition to drones.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

The novel features believed characteristic of the illustrative embodiments are set forth in the appended claims. The illustrative embodiments, however, as well as a preferred mode of use, further objectives, and features thereof will best be understood by reference to the following detailed description of illustrative embodiments of the present disclosure when read in conjunction with the accompanying drawings, wherein:

FIG. 1 depicts an overall schematic diagram of the components of a Safe Autonomous Light Aircraft

FIG. 2 depicts a Safe Autonomous Light Aircraft implemented for human transportation.

### BRIEF SUMMARY OF THE INVENTION

In an embodiment, a Safe Automated Light Aircraft (SALA) vehicle system as defined by aircraft regulations for weight class and payload utilizes autonomous and/or automated control to fly from source to destination point without the requirement of an on-board certified pilot which communicates and/or cooperates with street traffic signals and/or regulations as well as air traffic and airport instructions, procedures, and methodology. Autonomous control can be via a remote pilot. Autonomous control can be implemented on the craft. Autonomous control can be implemented with a Safe Temporal Vector Integration Engine (STeVIE). Lliftoff and/or landing sites can be coordinated with street light traffic control systems. The SALA can be utilized for package and/or cargo delivery. Some number of human occupants can be transported. A user interface, mobile communications device, computer or Internet connected device can be used to request the vehicle for transport. Dedicated safety launch/landing pads can be placed in specific locations for human transport and/or package and/or cargo pickup and/or delivery. Protective devices or configurations can be actuated when grounded to protect humans, pets, or animals from the propulsion system. The platform can coordinate with Air Traffic Control (ATC) or a third party dispatch system to define the navigation points, trajectory, and timing for the vehicle. The navigation points can be designed by a human user interface system and loaded into the craft but if necessary the ATC or third party dispatch system still validates the navigation plan. Weight limits can be modified by the local laws and jurisdictions. The platform can be configured as a drone carrier with hard automated docking of the secondary platforms including additional drone carriers. Additional drive wheels or surface drive wheels can be implemented in combination of other aircraft components such as but not limited to engine covers and/or landing gear can be driven to provide motive power to the platform on surface roads. Additional drive wheels or surface drive wheels can be implemented in combination of other aircraft components such as but not limited to engine covers and/or landing gear can provide steering and surface traction to the platform on surface roads but motive power is provided by other means than driving the wheels. All movement air, land, or sea can be controlled by the automation and/or autonomy systems. Land movement can be allowed as a manual override via the occupant or a remote driver, but all air movement can be controlled by the automation systems. An assigned trajectory can be loaded into the platform before takeoff or while in a holding location and altitude pending the flight trajectory plan. A multidimensional (for example without limitation 3 or 4) inverse-geofence or Free Flight Corridor structure can be loaded into the platform before takeoff or while in a holding location and altitude pending the flight trajectory plan.

An autonomous light aircraft may be distinguished in part by a total vehicle weight of more than 212 pounds and less than 1,320 pounds but without the requirement of a human pilot on board. In one embodiment this could be achieved by a remote pilot, but in order to design the system for maximum safety to the general public and the occupants, a Safe Autonomous Light Aircraft (SALA) is distinguished by a fully autonomous and/or automated flight system such as but not limited to the Safe Temporal Vector Integration Engine (STeVIE) which utilizes a splinebased 4D mathematical trajectory model of the navigation path hereinafter referred to as a trackpath which may be computed by a 4D autorouter for increased accuracy and safety.

The benefit of such a system is that once a source and destination point is input to the Air Traffic Control (ATC) system that handles Unmanned Aerial Vehicles (UAV) and Autonomous Aerial Vehicles (AAV), the same system can plot in 4 dimensions the optimum path for the SALA vehicles as well as taking all other known traffic into account. Once the flight path and timing for this vehicle is established, it's simply an AAV with larger payload. The STeVIE system is designed to follow its trackpath with high accuracy, it has built-in avoidance of the inverse-geofence or Free Flight Corridor (FFC) restriction of its flight path, obstacle avoidance within the FFC, and terminal guidance to land the vehicle safely even in the case of emergency.

While certification of these vehicles for human occupancy may take some time, they can be utilized more readily as autonomous cargo carriers and drone carrier vehicles. Vehicle safety may also be assured via certification standards such as IEC6 1 508 Functional Safety.

### DETAILED DESCRIPTON OF THE INVENTION

The following detailed description illustrates embodiments of the invention by way of example and not by way of limitation. The description clearly enables one skilled in the art to make and use the disclosure, describes several embodiments, adaptations, variations, alternatives, and use of the disclosure, including what is currently believed to be the best mode of carrying out the disclosure. The disclosure is described as applied to an exemplary embodiment namely, systems and methods for the creation of a safe autonomous light aircraft command and control system. However, it is contemplated that this disclosure has general application to vehicle management systems in industrial, commercial, military, and residential applications.

As used herein, an element or step recited in the singular and preceded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

The different illustrative embodiments recognize and take into account a number of different considerations. “A number”, as used herein with reference to items, means one or more items. For example, “a number of different considerations” means one or more different considerations. “Some number”, as used herein with reference to items, may mean zero or more items.

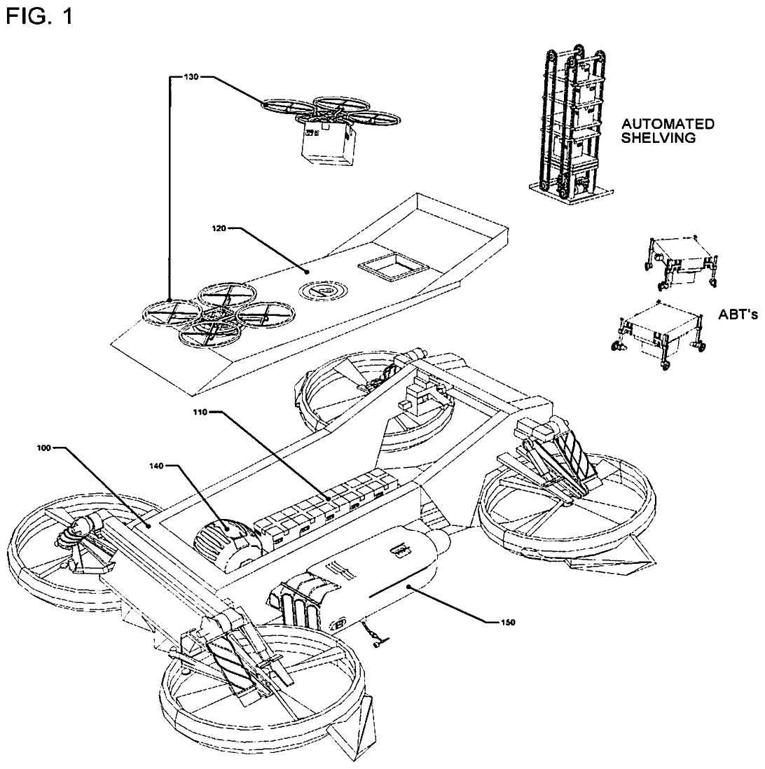

FIG. 1 depicts the overall components of a Safe Automated Light Aircraft. In one embodiment this vehicle may be implemented as an air cargo carrier. In other embodiments it could be utilized as a drone carrier providing automated docking and undocking facilities for other AAVs which perform the function of last mile delivery from the SALA.

The system consists of the platform 100 and cargo area 110. In one embodiment the cargo area is configured to allow for automated loading and unloading by Automated Box Transfer Vehicles (ABT) and automated shelving. In another embodiment it might simply be a cargo carrier with random boxes or other containers. In a drone carrier configuration a docking platform 120 is provided for one or more AAVs 130 which can receive the packages from the loading platform. Once the AAV has grasped and tested the package for flight, the SALA automatically requests a flight path from the ATC from its current location to the package destination.

In another embodiment if no ATC is available, a base plus offset trackpath can be automatically designed by a processing system within the SALA, or requested from another third party distribution control center. The AAV may then deliver the package, possibly return with another package, and at the end of the sequence hard dock with the SALA for return to the distribution center.

The SALA may contain an autonomous control system 140 such as but not limited to a Safe Temporal Vector Integration Engine (STeVIE) for flight control and one or more high efficiency motor-generator sets 150 to generate propulsive power. In other embodiments actual motorized propeller and/or ducted fan propulsion could be implemented. The SALA, as part of the STeVIE implementation would also implement a suite of 3D imaging systems and other instruments to provide for collision avoidance and flight controls.

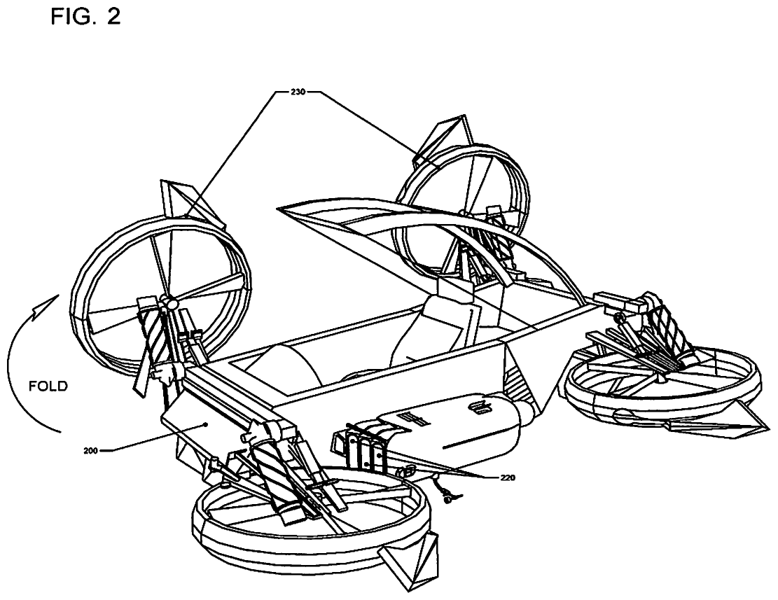

In FIG. 2, a SALA is depicted configured for human transport. In most safe autonomous craft the primary consideration is keeping people away from the vehicle. In this case it is a necessity at loading and unloading. The vehicle itself 200 has all of the components of the SALA described in FIG. 1, but includes a User Interface 210 and some methodology of protecting the occupants or nearby humans from the propulsion system.

In one embodiment covers 220 slide into place once landing is achieved covering the ducted fan inputs. In another embodiment, in order to facilitate loading and unloading and present a smaller footprint, one or both of the vehicle sides 230 is folded vertically or raised above the entrance to the passenger compartment. For more complete protection, both systems or other protection could be utilized.

Additionally in one embodiment the source and landing points may not be secured. In another embodiment, due to the danger to humans, specific boarding and/or landing points could be defined, or a combination such as but not limited to a specific boarding area, but the ability to land at the passenger's residence where they can guarantee the security required for landing.

In another embodiment automated takeoff and landing platforms can be set up at building rooftops and certain street level locations. These could be implemented for example without limitation as trailers, driveable vehicles, automated vehicles, and/or deployable barriers. These can be deployed quickly, implemented as street vehicles or placed in rooftop or other locations and can be redeployed to other locations as required. For example, during business hours they could be removed from the streets if demand in the area is low and/or traffic is high, and brought out during evening hours. In another embodiment they may be moved from one area to another depending on demand.

In another embodiment a sensing and control system could be implemented which allows a SALA to land at any intersection with one or more stoplights in control of each street branch. The SALA landing can be coordinated with the traffic light control system through a number of means and when the craft is ready to land all four lights turn red, stopping traffic for the length of time the SALA disembarks its passengers and takes off again. This timing may be automated or determined by the number of vehicles landing and taking off and their status.

In another embodiment the propulsion system covers 230 may also serve as surface wheels such that in one of their folded positions they may drive the vehicle on the surface road to clear the intersection.

Once the passengers are seated and secured, the user interface allows the user to enter the destination coordinates. In another embodiment this could have already been scheduled by any communications and/or Internet capable device such as but not limited to a smart phone, tablet, or personal computer. If this is a pay-for-use transport service, payment could be taken at time of boarding or prepaid. In another embodiment identification of one or more of the occupants could be required before the system commits to liftoff

Once the flight path is computed either by the Air Traffic Control or another third party service the launch time is set and SALA launches to complete the flight. This type of transform is differentiated from the concept of a “driverless car” by the fact that this airspace is primarily controlled for every air vehicle by the ATC, where roads are primarily occupied by human piloted vehicles with minimal traffic control. In another embodiment the SALA may be allowed to liftoff to a designated staging altitude to clear the street while air traffic control approval is pending.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. Further, different illustrative embodiments may provide different benefits as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A method of operating an autonomous aerial vehicle comprising:
flying an autonomous aerial vehicle to a street intersection having at least one traffic signal;
controlling the traffic signal to halt surface vehicle traffic at the intersection; and
landing the autonomous aerial vehicle at the intersection.
